(19) United States
(12) Patent Application Publication
(10) Pub. No.: US 2014/0058708 A1
(43) Pub. Date: Feb. 27, 2014

(54) COMPUTER-IMPLEMENTED METHOD OF SIMPLIFYING A COMPLEX PART IN A GEOMETRIC MODEL

(71) Applicant: FUJITSU LIMITED, Kawasaki-shi (JP)

(72) Inventors: Makoto SAKAIRI, Kawasaki (JP); Peter CHOW, Gillingham (GB); Fumihiro MARUYAMA, Kawasaki (JP); Tetsuyuki KUBOTA, Kawasaki (JP)

(73) Assignee: FUJITSU LIMITED, Kawasaki-shi (JP)

(21) Appl. No.: 14/070,967

(22) Filed: Nov. 4, 2013

Related U.S. Application Data
(63) Continuation of application No. PCT/EP2011/057079, filed on May 3, 2011.

(51) Int. Cl. G06F 17/50

(52) U.S. Cl. CPC G06F 17/50
USPC 703/1

(57) ABSTRACT

A computer-implemented method of simplifying a complex part in a geometric model by approximating its shape, including creating a two-dimensional cross-sectional plane through the complex part in at least two of three mutually orthogonal axes of the part, to give two or three planes, each reproducing the shape of the complex part at the cross section; and performing a combination operation on the planes to form a new body from the planes.

### CROSS-REFERENCE TO RELATED APPLICATIONS

This application claims the benefit of International Application No. PCT/EP2011/057079, filed May 3, 2011, the disclosure of which is incorporated herein by reference.

### BACKGROUND OF THE INVENTION

1. Field of the Invention

The present invention relates to computer-aided design and engineering. In particular it relates to adaptation of a model created of an object in a computer environment, in order to render that model more suitable for analysis.

2. Description of the Related Art

This modification process is most commonly found in design and manufacturing processes. For example, an engineer may design a product prototype in the form of a component or complex part using a model in a CAD (computer-aided design) package such as AUTO CAD or Pro/ENGINEER and then wish to test the model for suitability of use. Such analysis of the virtual prototype/model may be required for specification requirements such as durability, health and safety demands and manufacturability. The design engineer may for instance wish to analyse the model in simulations to determine heat resistance, propagation of electromagnetic or other fields or stress-strain properties. This simulation process can refine product design without entailing the cost of actual manufacture and physical test. However, it is often necessary to modify the model so that it is simplified and can be more easily analysed.

One particular application of a modification process for a geometric model which may be relevant for the present invention is in simplification of architectural models of buildings, for example for providing/improving airflow or ventilation or for fire simulation. Modification before thermal cooling simulation of models for heat producing electronic devices such as computer servers and mobile communications devices is a further, specific application that is relevant to the present invention.

FIG. 1 shows an overview of the simulation process chain frequently found in design and manufacturing processes. The primary stages are as follows:

1. Geometry Creation: this is creating a geometric model in the spatial domain. Models are commonly created using a Computer-Aided Design (CAD) system. If the CAD model is not correct, for example does not define a watertight solid or uses multiple definitions to cover a single plane, a CAD repair/merge stage may be required.

2. Model Setup: this is preparation, for example model modification, mesh generation and setup of model analysis conditions. Using an un-modified model directly for analysis is possible but comes at a great expense in computing resources and analysis time. The common practice in industry is to include an intermediate stage called CAD-to-CAE model preparation (CCMP). This significantly reduces the model size (in terms of electronic storage) and prepares the model for various classes of analysis. Models usually require preparation in form of modification (sometimes known as defeaturing) to make them suitable for analysis/simulation. Until recently the CCMP stage has been labour intensive and largely a manual process. With the development of computer-aided tools that automatically detect and process features, efficiency has significantly improved. The next step in model set up is mesh generation. Automatic and fast mesh generation is available for both structured (finite difference) and unstructured (finite element) meshes. The final step, setting of model analysis conditions, is dependent on the type of analysis, such as heat flow analysis, fluid flow analysis and stress analysis.

3. Analysis: this is using a computer system to undertake simulation and analysis. Analysis may include calculation to numerical solution of properties such as mechanical stress, fluid flow and electromagnetic properties which are important in design and manufacturing. In the case of electronic products, the common analyses are finite element analysis (FEA) of stress/strain (in drop/crash tests), electromagnetic interference and thermal-fluid cooling. Analysis used to be the most time consuming stage in the entire process but using parallel processing and advanced numerical methods this is no longer the case. With stages 2 and 4, analysis is referred to as Computer-Aided Engineering (CAE).

4. Visualisation: this is the opportunity to view and interpret analysis results. Commonly, 3D animations and plots of field values against specific parameters such as time, energy, etc. are used to aid engineers and designers.

Today, the most time consuming elements in CAD/CAE are usually in the model preparation processing (CCMP). In the automobile industry it is reported to be over 80 per cent of the total time. A significant part of this is to do with modifying CAD models to make them suitable for a specific type of CAE application. If we can introduce automation and streamlining into the process, then further efficiency improvements can be achieved.

The present invention relates specifically to simplification of complex parts by approximation of their overall shape. One related-art form of approximation replaces complex parts (such as parts with a varying cross-section along at least one axis or parts which interact with other parts in the model) with a bounding box enclosing the part in 3D Cartesian coordinates.

The bounding box is created in a manner known to the skilled man. For any object defined in a geometric model, the upper and lower limit of the object is found in the x, y and z directions. From these measurements, a rectangular parallelepiped (a cuboid or cube) is formed. This is the bounding box which encloses a 3D part in Cartesian coordinates, extending from the lowest numerical value to the highest numerical value of any portion of the part in all three directions in a 3D Cartesian coordinate system.

Bounding boxes are used in the related art to simplify smaller parts in a geometrical model, such as connectors, bolts and other parts present within holes or slots of a larger part. These parts do not necessarily have a major influence on the conclusions reached in the subsequent analysis, but may impose a heavy processing burden if they are not modified, due to their non-uniform shape. Bounding boxes are a simple way of modifying such parts by approximating their shape.

Replacement with a bounding box may not however be suitable in some circumstances.

### SUMMARY OF THE INVENTION

According to a first aspect, embodiments of the invention provide a computer-implemented method of simplifying a complex part in a geometric model by approximating its shape, comprising creating a two-dimensional cross-sectional plane through the complex part in at least two of three mutually orthogonal axes of the part, to give two or three planes, each reproducing the shape of the complex part at the cross-section; and performing a combination operation on the planes to form a new body from the planes.

Thus embodiments of the invention allow a complex part, such as a connector, to be simplified to a form that reflects cross-sections of the part on at least two of its three axes. This advantageous solution provides more accuracy of shape approximation than a bounding box but still gives the benefit of providing a part that is simpler to analyse.

Parts which are simpler/constant in size along one axis may benefit from two cross-sectional plane approximation, whereas parts which vary in size in all three axis or interact more with surrounding parts may require three cross-sectional plane approximation.

There are several circumstances in which the related art bounding box method is not suitable. For example, if the volume of the part is important in subsequent analysis, and the shape of the part is such that it has a much smaller volume than its bounding box, then the bounding box method may produce inaccurate results. This is particularly true if the analysis includes airflow calculations across gaps between the complex part and one or more other parts. Retention of such gaps is essential for airflow analysis, to prevent incorrect results.

A perhaps more common example is that a bounding box created around a part leads to interference with (that is overlap with the solid portion of) at least one adjacent part. The change in shape from the original part to the bounding box affects another part in the model and leads to a conflict. One example of a situation in which this might frequently occur is when the part which is to be simplified passes through another part via a hole or a slot or is at least partially inserted in another part. In these situations, one or both parts are likely to be shaped to retain the parts in a particular relationship, for example using abutments. This shaping can lead to difficulties once the part for insertion has been simplified using a bounding box.

Thus in preferred embodiments the complex part has a varying cross-section along at least one its mutually orthogonal axes. These are the x, y and z axes in which the part is defined.

Each cross-sectional plane may be created at any suitable position. For example, a position along the relevant axis can be selected that gives the largest area of the cross-section. For simplicity however, each cross-sectional plane may be created at the centre of the complex part. This can be a default setting, which can be altered by the user for example with a graphical user interface (GUI) as described hereinafter.

The planes may be created by any suitable operation available in the CAD environment. In one embodiment, the planes are created by a Boolean cut operation, which extracts each plane.

Boolean operations as used in CAD applications are operations on sets which are known to the skilled person, such as the union operation, the intersection operation and the difference operation.

Following the creation of the planes, they are combined in a combination operation. This combination operation can be any that uses the planes themselves to form a new body. The new body is a three-dimensional entity and one advantageous way of producing a three-dimensional body from a two-dimensional plane is to use a sweep or extrude operation, for example in which the plane is extruded along its normal to produce a 3D body with a cross-section of the plane and a third-dimension.

It is possible to use the data from each plane only in the combination operation to form the new body.

However, one advantageous way of combining the planes is to first use the sweep operation and then a subsequent intersection operation to select only those portions of the new body which are present in all two/three of the temporary bodies created using the extruded planes.

Therefore, according to preferred embodiments to combine the planes, each plane undergoes a sweep operation outwards along its normal in both directions to extrude it to the end of a bounding box containing the complex part and then the temporary bodies thus created are combined using a Boolean intersection operation to form the new body.

The bounding box acts as a limit for the initial extrusion process which is easily produced. Use of the sweep operation to the bounding box followed by the intersection operation allow efficient production of a new body using commands already available in CAD systems or other geometric modelling systems.

The shape approximation described above may be the first step in simplifying a complex part, but one or more preparatory stages may alternatively be included. One advantageous preparatory action is to remove small features from the part before shape approximation. For example, small protrusions on the part can unnecessarily complicate the cross-section produced subsequently. The same is true of small concave features. Both types of feature can also distort the cross-sections produced, leading to a significantly greater (or for concave features smaller) volume of the new body created by the plane combination.

The term small in this sense is intended to include features whose scale is smaller than the part on which they are present. For example, a feature may be defined as small if it is less than a predetermined size. The size of the feature may be determined for example according to volume of the feature or any other size parameter of the feature or of one or more individual surfaces making up the feature.

Once any preparatory stage has taken place, there may be an initial shape approximation stage before the cross-section method is used. For example, this stage could check whether approximation using a bounding box would be sufficient. The initial shape approximation stage can be particularly suitable for use when one of the primary considerations is interference between the part and any other adjacent part. Embodiments of the invention may preferably therefore provide an initial shape approximation stage of surrounding the complex part with a bounding box; and checking for any interference between the bounding box and any other part in the model, wherein the remaining method steps are carried out only when interference is detected.

Equally, further refinement can take place once the new body has been created. For example, if the new body is unsuitable (which may be determined manually or automatically) then there may be a stage in which an improved approximation is made. Using the example of interference again, invention embodiments may provide an improved approximation of the shape by subdivision of the part if there is interference between the new body and any other part in the model. Thus an improved body can be provided by looking separately at different portions of the part.

For example, in some embodiments the approximation may be improved by subdividing the complex part along at least one of its axes by creating one or more additional cross-sectional planes, the or each additional plane reproducing the shape of the complex part at that cross-section; combining the original planes and the one or more additional planes to form an improved body from the planes; and replacing the complex part in the geometric model with the improved body. Here, subdivision is by creation of one or more additional cross-sectional planes. This could take place in one axis, two axes or all three axes. The process could be user-driven or automatic. In a preferred automatic process, the subdivision is in all three axes.

The position of the additional planes can be any that is suitable for the particular model/part. In a preferred subdivision, which may be the default in the system, the additional plane is created at two subdivision points. Each subdivision point can be situated centrally between the original cross-sectional plane and the end of the complex part in that axis (or at the end of the bounding box in that axis).

The combination process for all the planes can follow the same lines as for the original planes, using sweep and intersection methodology for example.

Thus in some preferred embodiments, to combine the original planes and any additional planes along a single axis, the original plane undergoes a bi-directional sweep operation along its normal to extrude it to the adjacent additional planes or (if there is no adjacent additional plane) to the end of the bounding box, and each additional plane undergoes a sweep operation along its normal to extrude it outwards to the end of the bounding box and then the temporary bodies thus created along each axis are combined using a Boolean intersection operation to form the improved body.

The subdivision and combination may be repeated if there is interference between the improved body and any other part in the model. This subdivision and combination can be repeated until there is no interference between the improved body and any other part in the model or until a limit for repetition is reached.

The skilled reader will appreciate that the repetitions of the subdivision and combination process are along the same lines as the first subdivision and combination process. That is, in preferred embodiments, subdivision occurs centrally between two previously provided cross-sectional planes and between the final cross-sectional plane at the end of the axis and the bounding box. In a sweep operation, the original plane still undergoes a bi-directional sweep and each other cross-sectional plane is swept outwards to the next cross-sectional plane or the end of the bounding box (for the final cross-sectional plane).

According to a further aspect of the invention, which may be freely combined with the other aspects, invention embodiments provide a graphical user interface for a computer-implemented method of simplifying a complex part in a geometric model by approximating its shape, wherein the graphical user interface, when operated displays the complex part; allows manual selection of an automatic simplification method for the part in which a two-dimensional cross-sectional plane through the complex part is created in at least two of three mutually orthogonal axes of the part, to give two or three planes, each reproducing the shape of the complex part at the cross-section; and in which the planes undergo a combination operation to form a new body from the planes; and displays the new body after the simplification.

A graphical user interface (GUI) is commonly provided as a computer software tool executed on a computing device such as a terminal which has at least a screen for display and input means for the user, such as a keyboard and mouse arrangement.

According to this aspect of the invention the GUI can allow viewing and/or manual input in the CCMP stage, facilitating the shape approximation routine if necessary.

For example, the GUI could allow the user to carry out any or all of the following functions to: specify the number of cross-sectional planes, (two or three) and their extrusion and intersection operations, specify where each original cross-sectional plane is created, request and/or carry out a preparatory stage of removing small features, request and/or carry out an initial shape approximation stage using a bounding box, and request and/or carry out an improved approximation of the shape or repetitions of an improved approximation of the shape. The GUI could also allow the user to set the number of iterations of the subdivision in the improved approximation, potentially on a per axis basis, or alternatively as an overall value.

According to a still further aspect of the invention, invention embodiments provide a computer program which when executed on a computing device provides the graphical user interface according to any of the preceding graphical user interface description or carries out the method of any of the preceding method description.

According to a final aspect of the present invention, invention embodiments provide a computer apparatus arranged to simplify a complex part in a geometric model by approximating its shape, comprising a plane creator arranged to create a two-dimensional cross-sectional plane through the complex part in at least two of three mutually orthogonal axes of the part, to give two or three planes, each reproducing the shape of the complex part at the cross section; and a plane combiner arranged to combine the planes in a combination operation to form a new body from the planes.

The skilled reader will appreciate that the functional terms of the plane creator and plane combiner may be embodied as one or more suitably programmed processors accessing memory and input/output devices as necessary. The same processor or processors can act as either the plane creator and/or the plane combiner.

The computer apparatus may further comprise input functionality to read in a CAD file storing the geometric model, output functionality to output a modified CAD file storing the simplified geometric model, and computing capacity operable to carry out the method as variously defined hereinbefore and including a plane creator module and a plane combiner module.

The computer apparatus may be provided as a computer aided engineering system, which may comprise a single computing device or a network of linked devices having central or distributed computing resources, such as memory and processing capability. In the latter case the method and any GUI functionality may be shared between users at different terminals. The input functionality may read in a CAD file and the output functionality may produce a CAD file of the same or a different format.

Features and sub-features of any of the aspects all form part of the same general invention concept and may be freely combined unless clearly incompatible.

### BRIEF DESCRIPTION OF THE DRAWINGS

Preferred features of the present invention will now be described, purely by way of example, with reference to the accompanying drawings, in which:

FIG. 1 is a schematic diagram showing a simulation process chain and processing time;

FIG. 2 is a flowchart showing a general embodiment of the invention;

FIG. 3 is a schematic diagram illustrating components of hardware that can be used with invention embodiments;

FIG. 4 shows an example of a connector and its shape approximation;

FIG. 5 shows some examples of bumps and pins that can be removed in a preparatory stage;

FIG. 6 shows the transition from the original connector part, to a version from which the pins have been removed, and then the following transition to a bounding box;

FIG. 7 shows an example of how the shape approximation process of invention embodiments can be implemented for a connector model;

FIG. 8 is a flowchart of a shape approximation method according to invention embodiments;

FIG. 9 is a schematic diagram of iterations in the process of shape approximation along the x axis;

FIG. 10 is an outline view of a GUI display environment;

FIG. 11 shows a flowchart of basic GUI processing;

FIG. 12 shows a flowchart of the GUI auto detector feature; and

FIG. 13 shows a flowchart of detailed GUI feature processing;

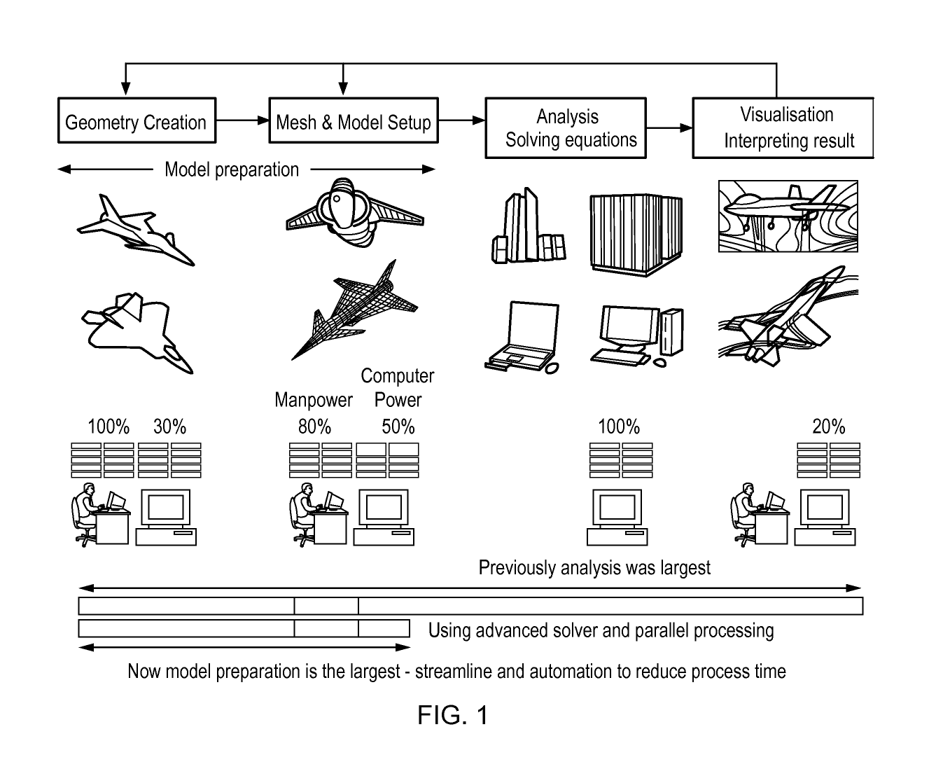

### DETAILED DESCRIPTION OF THE PREFERRED EMBODIMENTS

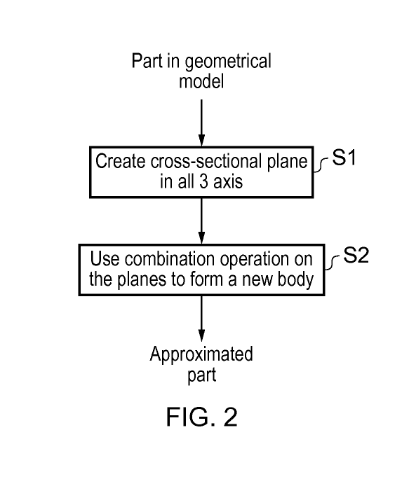

The flowchart shown in FIG. 2 converts a part in a geometrical model (which could be the only part in the geometrical model but is more likely to be one of many parts) into an approximated part using all three cross-sectional planes. If the part has an axis along which its shape is constant, the third cross-section may be omitted. The part may be, for example, a connector. Firstly in step S1 a cross-sectional plane is taken in each of the three axes of the part, by a plane creator. Parts are defined using Cartesian coordinates in CAD systems and it is the x, y and z axis that are used for the cross-sections.

In step S2 a plane combiner performs a combination operation on the three planes to form a new three-dimensional body. This new body is an approximated part which can be used in place of the actual part in the model to simplify subsequent analysis steps.

The method of invention embodiments can be entirely automatic, or there may be some user input. For example, a GUI may be provided that allows the user to view and/or influence any or all of the steps in the method.

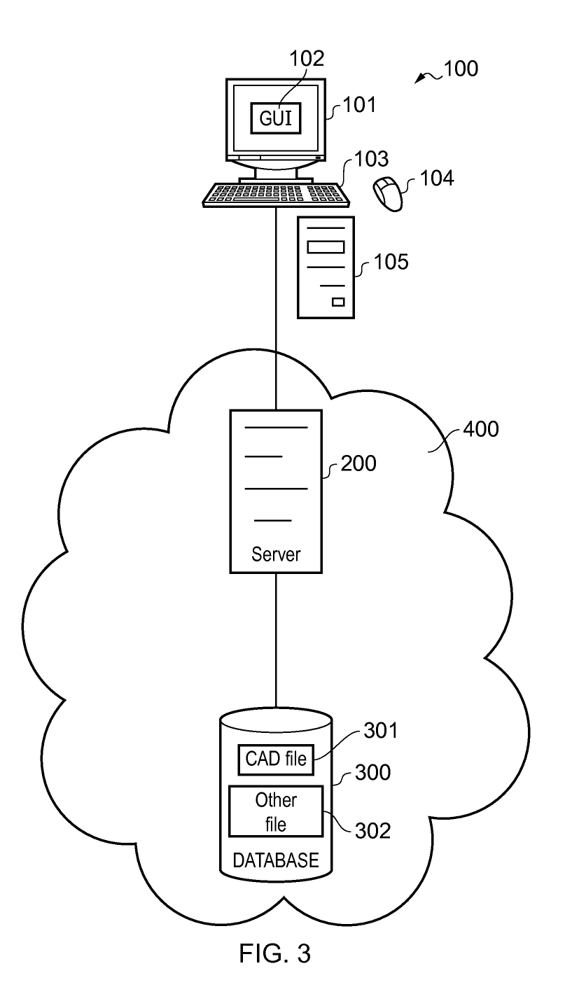

FIG. 3 is a schematic diagram illustrating components of hardware that can be used with invention embodiments. In one scenario, the invention embodiments can be brought into effect on a simple stand-alone PC or terminal 100 shown in FIG. 3. The terminal comprises a monitor 101, shown displaying a GUI 102, a keyboard 103, a mouse 104 and a tower 105 housing a CPU, RAM, one or more drives for removable media as well as other standard PC components which will be well known to the skilled person. Other hardware arrangements, such as laptops, iPads and tablet PCs in general could alternatively be provided. The software for carrying out the method of invention embodiments as well as a CAD data file and any other file required may be downloaded, for example over a network such as the internet, or using removable media. Any modified CAD file (for example, with at least one part replaced by a new body) can be written onto removable media or downloaded over a network.

Alternatively, PC 100 may act as a terminal and use one or more servers 200 to assist in carrying out the methods of invention embodiments. In this case, the CAD file 301 and/or software for carrying out the method of invention embodiments may be accessed from database 300 over a network and via server 200. The server 200 and/or database 300 may be provided as part of a cloud 400 of computing functionality accessed over a network to provide this functionality as a service. In this case, PC 100 may act as a dumb terminal for display, and user input and output only. Alternatively, some or all of the necessary software may be downloaded onto the local platform provided by tower 105 from the cloud for at least partial local execution of the method of invention embodiments.

### DETAILED EMBODIMENTS

Invention embodiments relate to the technology to set up models for CAE simulations. Especially, they focus on the technology to replace complex shaped parts with simple rectangular box shapes.

When thermal fluid analysis and structural analysis are carried out, parts that do not influence the numerical result may be replaced with simpler shapes. The example discussed here is a connector in a computer or mobile device, that can be replaced with a simpler, solid shape.

If we consider for example parts with blend features, simplifying the blends to rectangular features will reduce the mesh size significantly. Where blends are present, small mesh elements are required to accurately represent the curve shape, whereas rectangular features do not have this requirement, so bigger mesh elements and a smaller mesh size in terms of processing and storage can be employed. Also, larger elements allow larger time step values to be used, reducing the number of time-steps in transient simulations leading to shorter analysis time. Thus, due to the limitations of the computer such as memory etc. and the influences of the mesh size on the computing time required for analysis, it is important to replace features with simpler shapes or to modify the shape.

It is possible to remove blend and chamfer shape features with available software (for instance, CADDoctor) on the market. However, it is difficult to detect and remove complex features automatically. Using related-art CCMP (CAD-to-CAE model preparation) technology it is possible to remove many complex shapes including bumps and pins. Without such software tools, the designer must return to the CAD software to find and remove these features manually. This is tedious and extremely time consuming.

In the related art, a complex shaped part such as a connector part model with small bumps and pins may be replaced by a rectangular box using a bounding-box method. As previously discussed, there is a possibility of interference between bounding box adjacent parts. Removing small bumps and pins before the bounding-box stage is a related art way of simplification which helps prevent interferences.

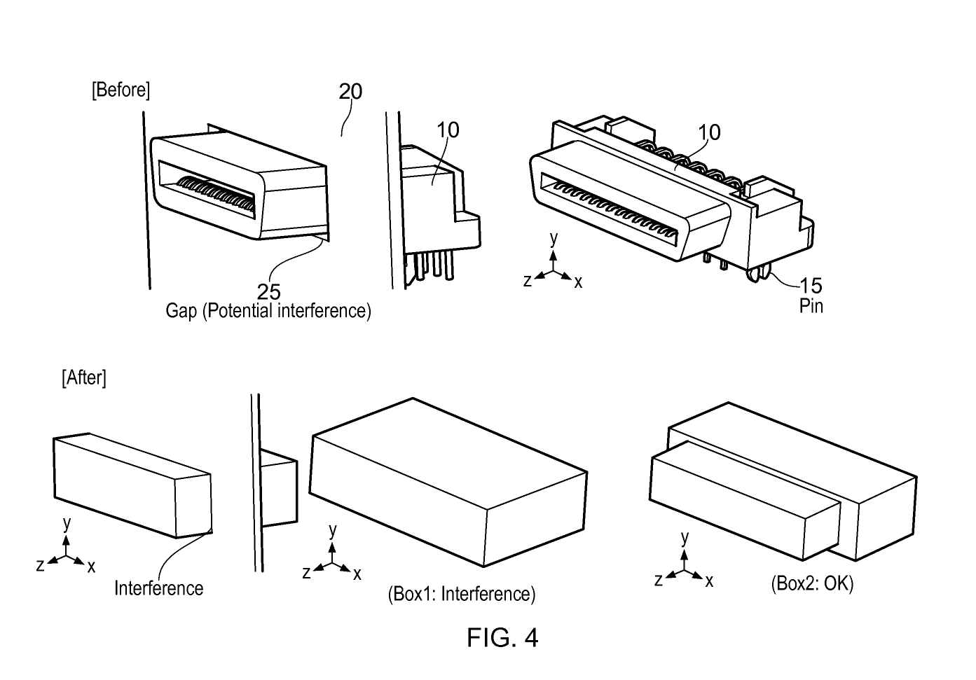

However, there are many situations where one part goes through another part, at least partially, for example via a hole or slot and in these cases removal of small features is not sufficient to prevent interference. FIG. 4 shows an example of a connector 10 having pins 15 which passes through a panel 20 with a slot 25. The interaction between the parts is important. FIG. 4 shows that a bounding box around connector 10 (even if the pins are first removed) will result in interference with panel 20. However the box created using the process of invention embodiments produces a shape that does not overlap with the panel.

A manual process of checking when adjacent parts are simplified is tedious and time consuming to do as interferences must be investigated and resolved. This is not a simple task, especially there are many parts.

Invention embodiments change a complex shaped part, such as the connector in FIG. 4, to a rectangular box-based part that can more easily be interference free with adjacent parts. The process of this embodiment consists of two stages; the preparatory stage uses related art technologies to remove small features while the following stage approximates the shape of the connector.

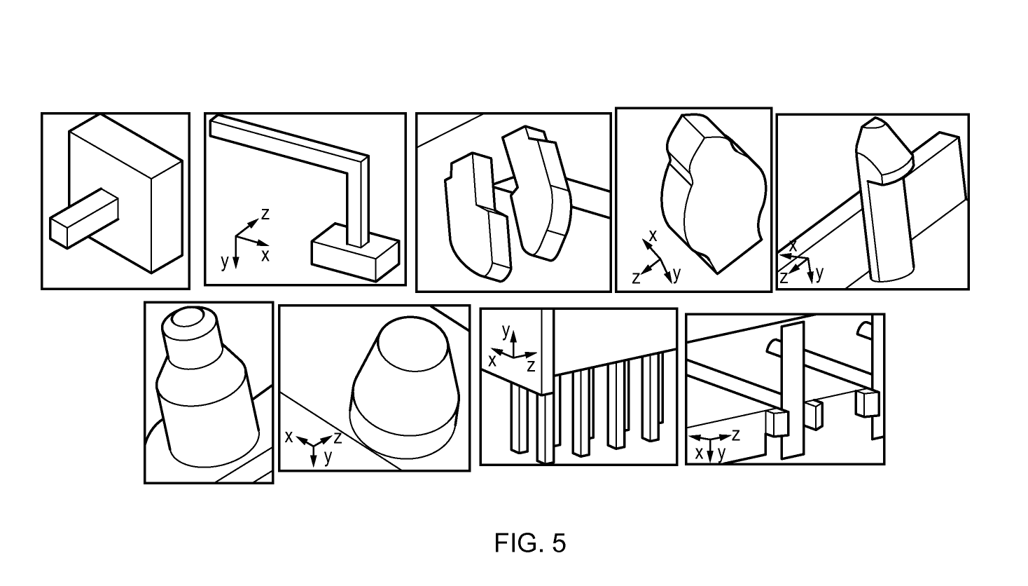

FIG. 5 shows some examples of bumps and pins that can be removed in the preparatory stage. The reader is referred to PCT/EP2010/070605 and PCT/EP2010/070601 which are previous applications by the same applicant and disclose a technology for automatic feature detection of small features. These applications are hereby incorporated herein by reference.

The preparatory stage uses existing technology from the previous applications, to automatically detect and remove small bumps and pins such as those in FIG. 5 using feature characteristics as described in the previous applications. The resulting part is a model free of small bumps and pins and ready for the shape approximation stage of the process.

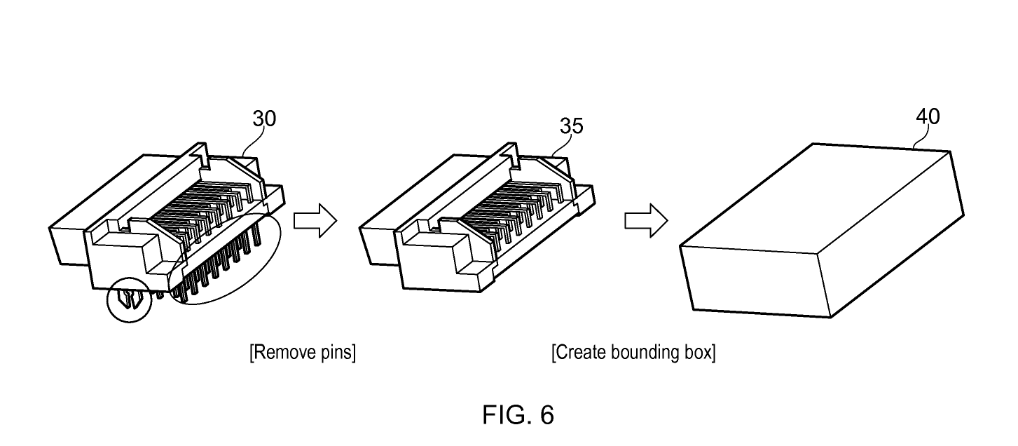

FIG. 6 shows the transition from the original connector part 30, to a version from which the pins have been removed 35, and then the following transition to a bounding box 40. Covering the part with a bounding box is the first action a) in the approximation stage. This would be the end result if there are no interfaces with adjacent parts. The full approximation stage for this embodiment is set out below:

a) Replace the complex shaped part with a bounding-box and check whether there are interferences with adjacent parts or not. If there are interferences then proceed to step b) otherwise the part is replaced with a body based on the bounding box.

b) Create a two-dimensional cross-sectional plane at the center of the complex shaped part in each of the three axes. This can be achieved by a Boolean cut operation or something similar to extract each plane. Then with each plane create a new body by using the sweep operation from the middle to each end of bounding-box limits. The three new bodies are then combined using a Boolean intersection operation to produce a body/part that is the intersection of all three bodies.

c) Check whether there are interferences with adjacent parts or not. If there are interferences then proceed to step d) otherwise the part is replaced with the new body.

d) Increase the number of cross-sectional planes by subdividing using the original part to attain more precision. Extrude the planes between the subdivisions to obtain the new bodies in each axis. Combine the three bodies with a Boolean intersection operation to produce a body/part that is the intersection of all three.

Check whether there are interfaces with adjacent parts or not. If there are interferences then repeat the step until there are no interferences or the repeat limit (set by users or using a default of say 100) is exceeded. In case of exceeded repeat limit, the approximation stage returns a failed condition.

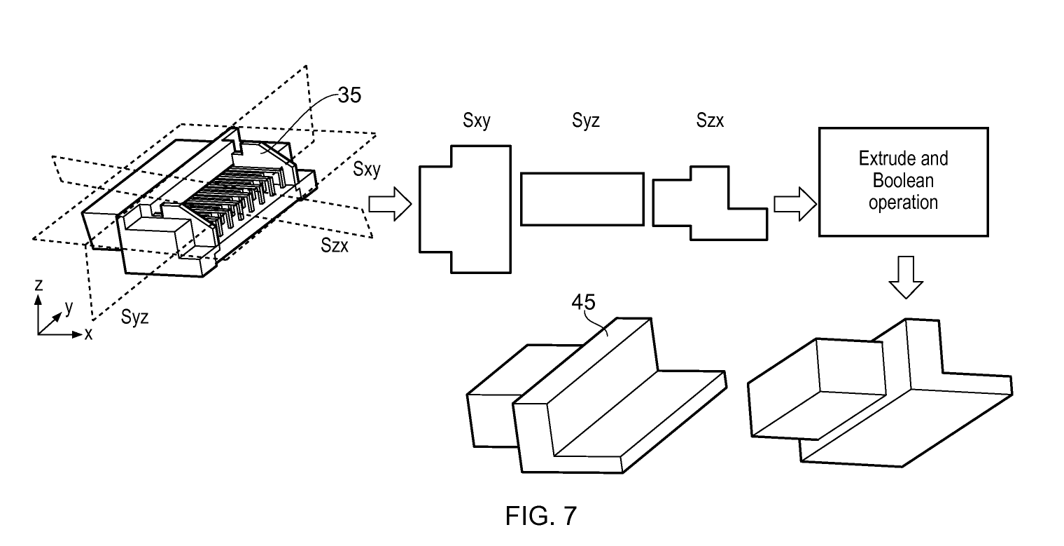

FIG. 7 shows an example of step b) of the process for a connector model. The part is version 35 from which pins have previously been removed. FIG. 7 demonstrates the three central cross sections, Sxy, Syz and Szx. These are extruded and a Boolean operation is used to form the new body 45.

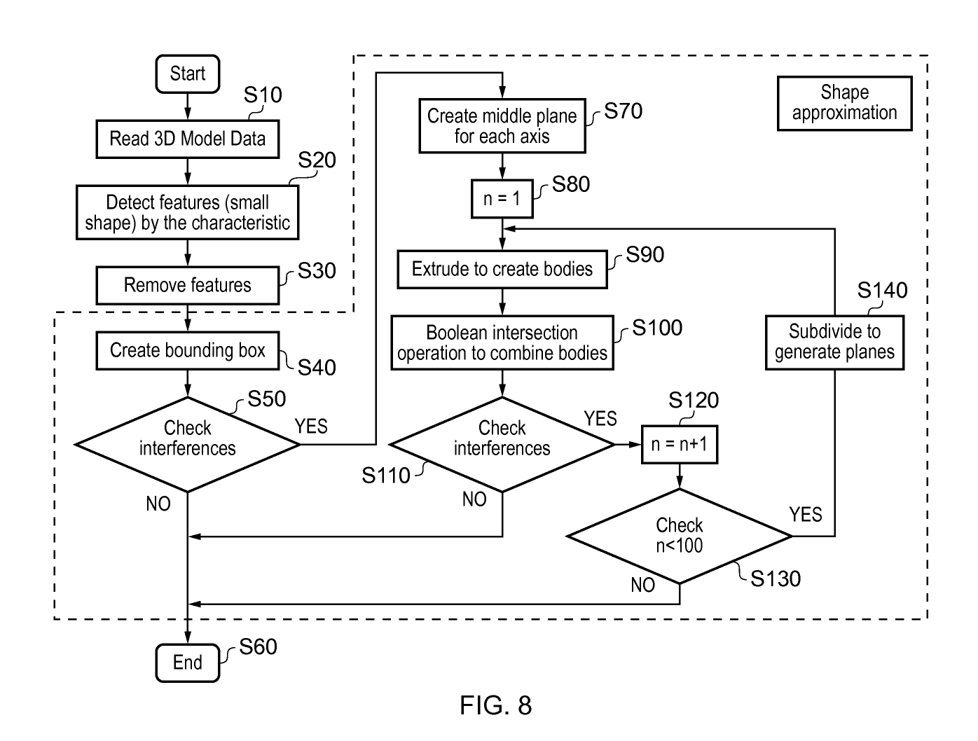

FIG. 8 is a flowchart of an automatic overall shape change process. In step S10 the 3D model data is read. In step S20 the small features are detected using their characteristics. In step S30 these small features are removed. The next steps are all part of the shape approximation method. In steps S40 a bounding box is created around the part which is being processed. In step S50 there is a check for interferences and if there are no interferences the process ends in step S60. If on the other hand there are interferences or at least one interference, a middle plane for each axis is created for the part in step S70. In a first iteration where n is set to 1 in step S80, the planes are extruded to create bodies in step S90 and then a Boolean intersection operation is carried out on the bodies to combine them in step S100. In step S110 there is a second check for interferences. If there are no interferences the process ends in step S60. If there is at least one interference the counter n is incremented in step S120 and there is a check in step S130 whether n is less than 100. If n is 100 or more the process ends with a failure at step S60. If n is less than 100 there is a subdivision to generate at least one additional plane in step S140 and then a loop back to the extrusion to create a new body.

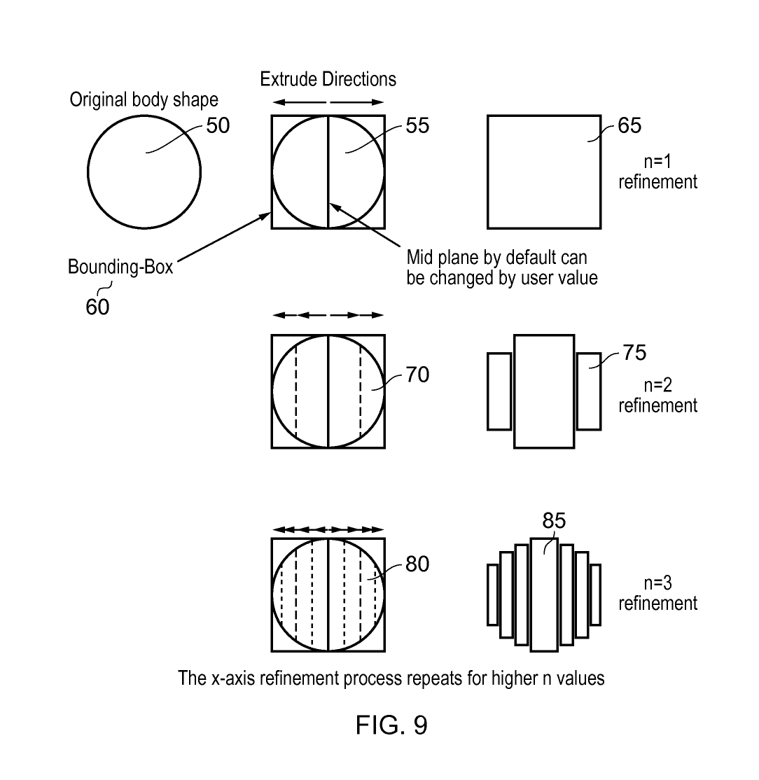

FIG. 9 demonstrates a middle plane and subdivision process for an original body shape of a sphere or other part with a circular cross-section. The refinement process is shown in the x axis only. Initially a middle plane is created only, as per step S70 in FIG. 8. At this stage the counter n equals 1. The original body shape is shown as part 50. The first division step forms the mid plane using bounding box 60 and produces divided part 55. Extrusion results in the square cross-section new body shown as 65. In the first subdivision step, n equals 2 and there are 2 additional cross-sectional planes created as shown by subdivided part 70. The additional planes are midway between the middle plane and the end of the bounding box, to either side of the bounding box centre. Extrusion results in a new body with the cross-section shown as 75.

In a second refinement step, the subdivision has taken place again to provide 4 new additional cross-sectional planes. Each new additional plane is at the mid point between two previously created planes or, for the new additional planes at each edge, between the end of the bounding box and the previous end additional plane. Extrusion of the planes from the centre outwards creates the cross-section shown as 85 in the diagram.

Extrusion takes place in both directions from the mid plane, but in one direction only for each additional plane, away from the centre towards the bounding box limits.

GRAPHICAL USER INTERFACE

Some objects of the GUI tool are to:
1. Provide users with a graphical environment with processing tools for CAD model processing—with the automatic feature detection and modification technologies described above.
2. To view the features failed in the modification process (perhaps first to run feature detection to show these features) and then help users towards a remedy with toolset functions in the GUI.
3. To give the ability to view and share models between users at different locations via a network/communication medium.

The GUI aspect provides a graphical environment with 3-dimensional display of CAD models. User input functionality may be provided conventionally, with for example a mouse and a keyboard. FIG. 15 provides an outline of an on-screen display environment, and FIGS. 16 to 18 are flowcharts of the GUI CAD model processing.

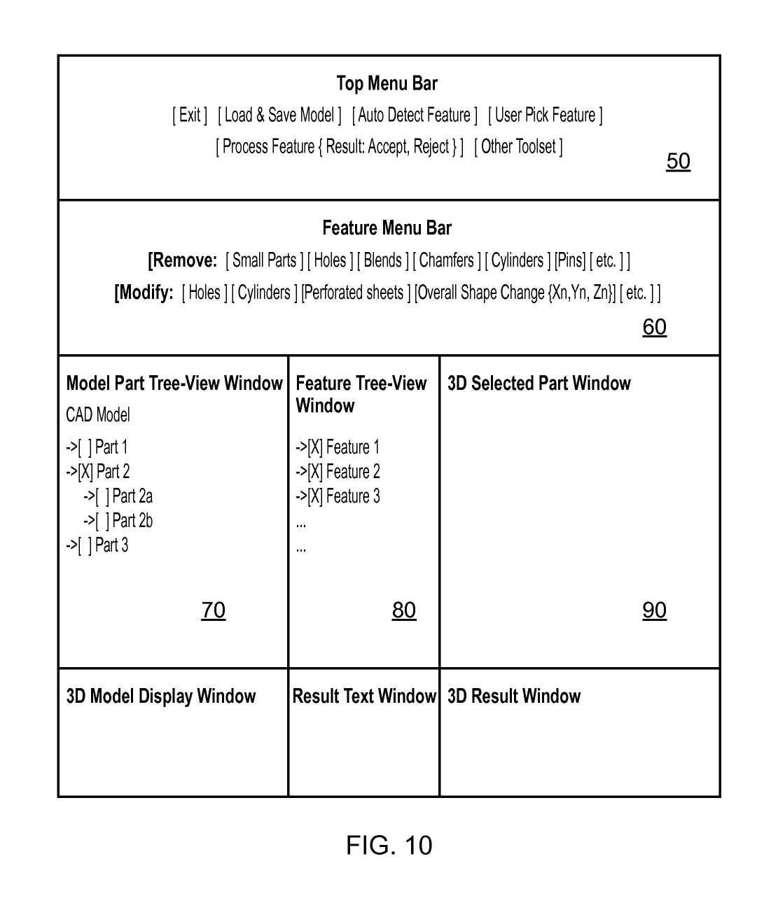

FIG. 10 shows an outline view of a GUI front end of the basic arrangement. A top menu bar 50 provides basic features of exit, load and save model, auto detection, user pick feature, feature processing with the results of accept or reject and any other suitable tools. A feature menu bar 60 below the top menu bar gives selected capabilities of removing small parts, holes, blends, chamfers, cylinders and other parts or modifying for example holes and cylinders as well as the simplification by cross-section as described in detail herein, which is entitled “Overall Shape Change”.

The GUI is enhanced with shape change options for users. The user can select and extrude one cross-sectional plane at a time, to form two or three separate temporary bodies, before combining them using a Boolean intersection operation.

Another element is an individual refinement (subdivision) level for each axis. In the example shown in FIG. 10, {Xn, Yn, Zn} in “Overall Shape Change” option is the refinement level option. In the present case it is constant for all axes. This is the n counter described in the previous figures, which has a minimum value of 1 for a three-plane process. This functionality gives users more control of overall shape change. For a two-plane shape change only, the counter can be set at 0 for one of the axes in the shape approximation.

Using a more advanced method can also employ this refinement approach in automatic overall shape change by refining one axis at a time. This may not be an advantage due to extra computing overheads common in advanced interference methods.

In the screen portion below the feature menu bar the screen is divided into three; a model part tree-view window 70 indicating which part of a model is being processed, a feature tree-view window 80 showing the features being processed and a 3D selected part window 90 highlighting detected features. In the lowermost portion of the screen there is also a division into three windows, a 3D model display window which shows a representation of the model, a result text window which gives the result of a process in text form, for example listing features detected and a defeaturing (modification) result. Finally a 3D result window shows the part as modified by the process.

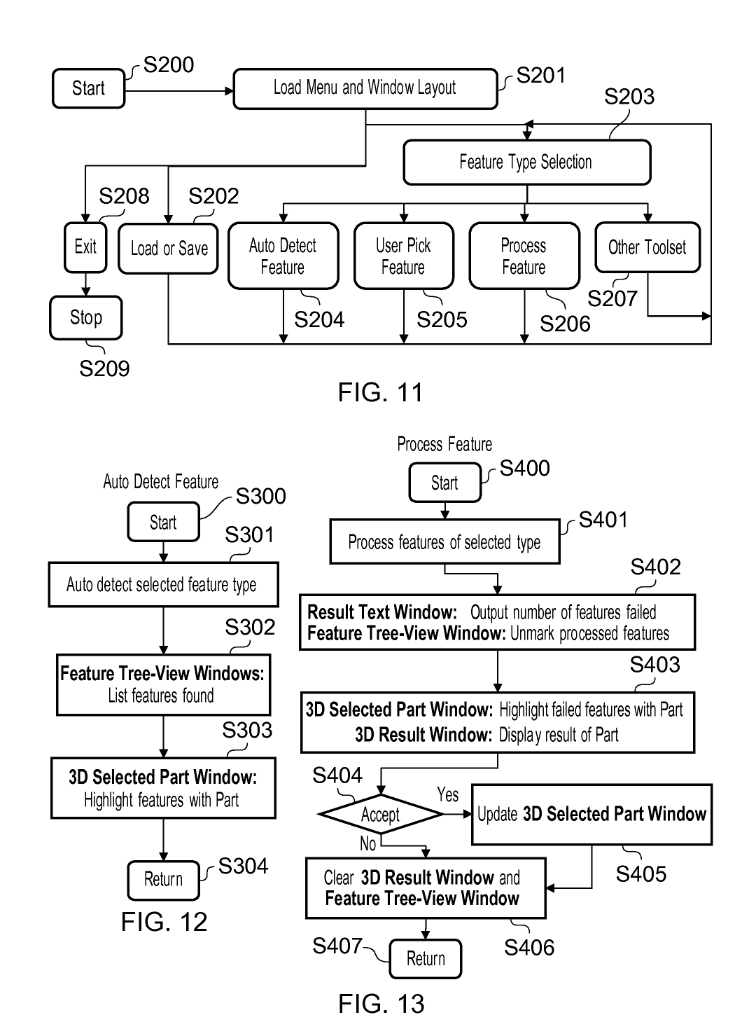

FIG. 11 shows an overall logical flow of functions within a GUI according to invention embodiments. The process starts at step S200 and in step S201 the menu and window layout is loaded. At step S202 a model is loaded or saved. Once the model has been loaded and saved into the system the process can continue with a feature type selection S203. For example, the feature selected may be overall shape change. In step S204 such features may be detected (in the case of overall shape change, the method can select a part or detect whether the part currently selected is suitable for such processing). In step S205 the user can manually pick the feature. In step S206 the feature is processed. Step S207 provides any other relevant functionality. At any point after one of these steps, a new model can be loaded or the current model saved and the process can exit in step S208.

FIG. 12 is a more detailed flow chart of the auto detect feature of step S204 on FIG. 11. The process starts at S300 and auto detects a selected feature type in step S301. In the next step S302, the features found are listed in the feature tree-view window shown in FIG. 15. In step S303 the features are highlighted on the part which is currently undergoing processing in the 3D selected part window.

FIG. 13 is a more detailed explanation of the process feature step shown as S206 in FIG. 11. A suitable example of a relevant feature type is the detection of small bumps and pins. The processing starts at S400 and processes features of the selected type in S401. In S402 the result text window outputs a number of features failed and the feature tree-view window unmarks processed features. In step S403 the 3D selected part window highlights failed features on the part and the 3D result window displays the results of the processing. If the result is accepted by the user in step S404 then the 3D selected part window is updated, if not the 3D result window is cleared and the feature tree-view window is cleared. Equally after updating the 3D selected part window these two windows are cleared. The process returns to the main loop in S407.

Finally, for the avoidance of doubt it is noted that invention embodiments also provide a computer program or a computer program product for carrying out any of the methods described herein, and a computer readable medium having stored thereon a program for carrying out any of the methods described herein. A computer program embodying the invention may be stored on a computer-readable medium, or it could, for example, be in the form of a signal such as a downloadable data signal provided from an Internet website, or it could be in any other form.

### ADVANTAGES OF INVENTION EMBODIMENTS

Using embodiments of the invention it is possible to reduce the set-up time for part modification, because the users do not need to spend time to check for interferences and re-modify the parts. So the method and computer apparatus of invention embodiments make it possible to reduce around the set-up time by, for example, five minutes per part which it is necessary to modify.

Additionally, since the device can reduce the number of mesh elements, the simulation time can also be reduced.

1. A computer-implemented method of simplifying a complex part in a geometric model by approximating its shape, comprising
creating a two-dimensional cross-sectional plane through the complex part in at least two of three mutually orthogonal axes of the part, to give two or three planes, each
reproducing the shape of the complex part at the cross section; and
performing a combination operation on the planes to form a new body from the planes.

2. A method according to claim 1, wherein
the complex part has a varying cross-section along at least one of its mutually orthogonal axes.

3. A method according to claim 1, wherein
each cross-sectional plane is created at the centre of the complex part, preferably by a Boolean cut operation.

4. A method according to claim 1, wherein
the planes are combined using a sweep operation, optionally followed by an intersection operation.

5. A method according to claim 1, wherein
to combine the planes, each plane undergoes a sweep operation outwards along its normal in both directions to extrude it to the end of a bounding box containing the complex part and then the two or three temporary bodies thus created are combined using a Boolean intersection operation to form the new body.

6. A method according to claim 1, further comprising a preparatory step of removing small features from the part before shape approximation.

7. A method according to claim 1, further comprising
an initial shape approximation stage of surrounding the complex part with a bounding box; and checking for any interference between the bounding box and any other part in the model, wherein the remaining method steps are carried out when interference is detected.

8. A method according to claim 1, further comprising
if there is interference between the new body and any other part in the model, making an improved approximation of the shape by subdivision of the part.

9. A method according to claim 8, wherein the approximation is improved by:
subdividing the complex part along at least one of its axes by creating one or more additional cross-sectional planes, the or each additional plane reproducing the shape of the complex part at that cross section;
combining the original planes and the one or more additional planes to form an improved body from the planes; and
replacing the complex part in the geometric model with the improved body.

10. A method according to claim 8, wherein
the subdivision creates the additional plane at two subdivision points, each situated centrally between the original cross-sectional plane and the end of the complex part in that axis.

11. A method according to claim 9, wherein
to combine the original planes and any additional planes along a single axis, the original plane undergoes a bi-directional sweep operation along its normal to extrude it to the adjacent additional planes or if there is no adjacent additional plane to the end of the bounding box, and each additional plane undergoes a sweep operation along its normal to extrude it outwards to the end of the bounding box and then the temporary bodies thus created along each axis are combined using a Boolean intersection operation to form the improved body.

12. A method according to claim 6, wherein
if there is interference between the improved body and any other part in the model, the subdivision and combination process is repeated, and preferably wherein
the subdivision and combination process is repeated until there is no interference between the improved body and any other part in the model or until a limit for repetition is reached.

13. A graphical user interface for a computer-implemented method of simplifying a complex part in a geometric model by approximating its shape, wherein the graphical user interface, when operated
displays the complex part;
allows manual selection of an automatic simplification method for the part in which a two-dimensional cross-sectional plane through the complex part is created in at least two of three mutually orthogonal axes of the part, to give two or three planes, each reproducing the shape of the complex part at the cross section; and in which the planes undergo a combination operation to form a new body from the planes; and
displays the new body after the simplification.

14. A non-transitory computer-readable medium storing a computer program which when executed on a computing device creating a two-dimensional cross-sectional plane through the complex part in at least two of three mutually orthogonal axes of the part, to give two or three planes, each reproducing the shape of the complex part at the cross section; and
performing a combination operation on the planes to form a new body from the planes

15. A computer apparatus arranged to simplify a complex part in a geometric model by approximating its shape, comprising
a plane creator arranged to create a two-dimensional cross-sectional plane through the complex part in at least two of three mutually orthogonal axes of the part, to give two or three planes, each reproducing the shape of the complex part at the cross section; and
a plane combiner arranged to combine the two or three planes in a combination operation to form a new body from the planes.
